(19) United States
(12) Patent Application Publication
(10) Pub. No.: US 2025/0039074 A1
(43) Pub. Date: Jan. 30, 2025

(54) SYSTEM AND METHODS FOR ROUTING INTERNET PROTOCOL, IP, TRAFFIC

(71) Applicant: VODAFONE IP LICENSING LIMITED, Newbury, Berkshire (GB)

(72) Inventors: Shifeeq AHMED, Newbury, Berkshire (GB); Mostafa Mahmoud Mohammed ELTAHER; Moamen Yehia AHMED; Stanislaw JAKIEL

(21) Appl. No.: 18/705,062

(22) PCT Filed: Oct. 21, 2022
(86) PCT No.: PCT/GB2022/052698

§ 371 Date: Apr. 26, 2024

(30) Foreign Application Priority Data
Oct. 29, 2021 (GB) 2115613.8

(51) Int. Cl. H04L 45/02; H04L 61/2592

(52) U.S. Cl. CPC H04L 45/02; H04L 61/2592

(57) ABSTRACT

The present application relates to network routing between networks where private routing tables are in use and remote networks. Overlapping IP address ranges may be in use in private networks, which may result IP clashes in the remote network. A system (400) for routing internet protocol, IP, traffic is provided. The system (400) comprises one or more consumer networks (410) each comprising a gateway (420) and one or more private networks (430). Each of the plurality of private networks serves one or more endpoints (440). The system (400) further comprises a remote network (450) comprising a router (460) for each of the plurality of private networks (430) in the consumer network (410). Each router (460) in the remote network has a unique identifier and is configured to establish a tunnel (470) between the router and the gateway (420) of the corresponding consumer network, so that each tunnel corresponds to a private network (430) of the one or more private networks (430) in the one or more consumer networks (410). The gateway (420) of each consumer network (410) is configured to receive upstream IP traffic, determine from which private network (430) the upstream IP traffic originates, and send the upstream IP traffic to the remote network (450) via the tunnel (470) corresponding to the private network (430) from which the upstream IP traffic originates.

### FIELD OF THE INVENTION

The present invention relates to network routing. In particular, the present invention relates to IP routing between networks where private routing tables are in use.

### BACKGROUND

### Glossary of Terms

IP (vX)—Internet Protocol (version X)
PGW—Packet Gateway
GRE—Generic Routing Encapsulation
CIDR—Class Inter-Domain Routing
IPBB—Internet Protocol BackBone
DM—Device Management
VRF—Virtual Routing and Forwarding
VCHS—Vodafone Common Hosting Services
AWS—Amazon Web Services
APNs—Access Point Names
IPSEC—Internet Protocol Security
GW—Gateway
FQDN—Fully Qualified Domain Name
NAT—Network Address Translation
MPBGP—Multiprotocol BGP
BGP—Border Gateway Protocol
GGSN—Gateway GPRS Support Node
GPRS—General Packet Radio Service
RT—Routing Table
RFC—Request For Comments
VPC—Virtual Private Cloud
E2E—End-to-End
LwM2M—Lightweight M2M
M2M—Machine-to-Machine
UDP—User Datagram Protocol
CSP—Cloud Service Provider
IKE—Internet Key Exchange

IPv4 address space is finite and limited. Currently, many devices only support IPv4 addressing. Therefore, IP address reuse is implemented to increase the number of possible endpoints served by a network. In order to do so, private routing tables may be used to assist with traffic routing.

Some network operators provide connectivity to customers of many different segments (of different sizes and in different industries). Typically, connectivity is provided in isolation from other customers, which is acceptable for each customer as the main requirement is to connect a device at one end to the customers systems at the other end. In other words, each customer has their own private network. Isolation means that IP addresses may be reused between different customer networks.

Connectivity may be provided to customers via a “pipe”. A pipe may refer to the a customer connection that is private from end-to-end. For example, Sim to BaseStation (private connection), BaseStation to PGW (GRE tunnelling), PGW to Edge router (VRF), and Edge Router to Customer site (IPSEC).

Some additional services, (such as Device Management) add value to the existing connectivity services provided by network operators. However some such additional services are required to be applied to all existing customers that were previously isolated from each other.

There is therefore a significant barrier to providing existing customers additional services (such as Device Management Services). In particular:
many disparate customers require connections to a single central solution, rather than their own systems;
disparate customers could have overlapping IP addresses for devices in their networks, which may lead to clashes between devices in different customer networks; and
customers could have IP addresses for devices in their networks that could clash with IP addresses for devices and servers in the data centre where additional services are hosted.

There is therefore a need to provide multiple private network with access to a central platform. The solution must automated/scalable for continued operation in future.

This is at least because there is a need to restrict the number of IP addresses allocated because the number of available addresses is limited. The number of available addresses will increase when IPv6 is supported (although this may not be for a number of years). Support for IPv4 solutions will be required in the interim.

To address the issue of IP clash, a proposed solution to the problem is to provide an IPSEC tunnel between each endpoint and the cloud network. However, such solutions require a large volume of networking resources to establish and maintain the tunnels and are not scalable/maintainable for large numbers of endpoints.

### SUMMARY

A system for routing internet protocol, IP, traffic is provided. The system comprises one or more consumer networks, each consumer network comprising a gateway and one or more private networks. Each of the one or more private networks serves one or more endpoints.

The system further comprises a remote network comprising a router for each of the one or more private networks in each of the one or more consumer networks. Each router in the remote network has a unique identifier and is configured to establish a tunnel between the router and the gateway of the corresponding consumer network (preferably via the Internet), so that each tunnel corresponds to a private network of the one or more private networks in the one or more consumer networks.

The gateway of each consumer network is configured to: receive upstream IP traffic; determine from which private network in the consumer network the upstream IP traffic originates; and send the upstream IP traffic to the remote network via the tunnel corresponding to the private network from which the upstream IP traffic originates.

The tunnels between router and gateway may be established via the Internet in some examples. In other examples, the system could be implemented in a totally private solution, so that the tunnels are established via an alternative network (such as a Mobile Private Network).

There is a router in the remote network for each private network, such that each private network has a corresponding router and each router may be configured to establish a tunnel to the gateway of the consumer network to which the corresponding private network belongs.

The remote network may comprise a router for each of the one or more private networks in each of the one or more consumer networks, such that the system comprises more than one private network. In other words, the system comprises a plurality of private networks. There may be a plurality of networks in one consumer network or there may be a plurality of consumer networks, each having one private network.

The IP ranges allocated to the one or more private networks may be overlapping with each other. In other words, the range of available IP addresses in a first of the private networks includes IP addresses that are also included in the rage of available IP addresses in a second private network.

A first endpoint may be served by a first private network of the one or more private networks in a first consumer network of the one or more consumer networks. A second endpoint separate from the first endpoint may be served by a second private network of the one or more private networks in the first consumer network. The first endpoint may have an IP address and the second endpoint may have an IP address that is the same as the IP address of the first endpoint.

A private routing table may be used within the first consumer network so that IP traffic to and from the first endpoint and IP traffic to and from the second endpoint is correctly routed within the first consumer network.

A first endpoint may be served by a private network of the one or more private networks in a first consumer network of the one or more consumer networks. A second endpoint separate from the first endpoint may be served by a private network of the one or more private networks in a second consumer network of the one or more consumer networks. The first endpoint may have an IP address that is the same as an IP address of the second endpoint.

It is possible for endpoints in the first and second consumer networks to overlap because the consumer networks are separate.

The proposed solution can mitigate IP clash in the remote network, where the remote network is in communication with a plurality of private networks having overlapping IP ranges. There may be a plurality of private networks in one consumer network or the private networks may be in different consumer networks.

A private network may be a portion of the consumer network that is allocated to a customer of the network operator (or a group of customers). Within the private network, IP addresses are unique. However, IP addresses in a first private network may overlap with IP addresses in a second private network. Each private network may be routed separately from the other private networks so that IP clash between private networks does not occur in the consumer network.

By providing a separate tunnel for each private network in each consumer network, the proposed system provides separation of traffic arriving at the remote network from the one or more consumer networks. This is especially useful where the remote network is not aware of the private routing table or does not support private routing tables. If the traffic arriving at the remote network were not separated in some way then the remote network would have no way of differentiating between traffic originating from the first and second endpoints, which share an IP address. Beneficially, using separate tunnels for each private network allows the remote network to distinguish between traffic from the different private networks and thereby prevent IP clashes between endpoints served by the private networks.

The proposed solution provides one router per private network. The solution is therefore highly scalable compared to previous systems, which required one router per endpoint.

By providing a separate router for each private network, the proposed solution is also highly available at the remote network side.

In other words, the private routing table allows traffic to be routed correctly within a consumer network. If it were not for the private routing table, there could be IP clashes on the consumer network side. The private routing table may not prevent IP clashes on the remote network side, however, since the remote network may be unaware of the private routing tables or may not support use of private routing tables. However, segregating the IP traffic into a separate tunnel for each of the private networks allows the remote network to differentiate between the traffic and prevent IP clashes in the remote network.

In the context of this application “upstream” IP traffic is used to refer to IP traffic sent from a consumer network to the remote network and “downstream” is used to refer to data sent from the remote network to an endpoint in a consumer network. In other words, upstream IP traffic originates from an endpoint in a consumer network and downstream traffic is sent to an endpoint in a consumer network.

As mentioned above, each tunnel corresponds to a private network of the one or more private networks in the one or more consumer network. By extension, each router may also correspond to a private network. Likewise, each private network also has a corresponding router.

A consumer network may be an IP backbone, IPBB, network. An “IP backbone, IPBB, network” can also be called a “core network”. Alternatively, a “consumer network” may be an entire mobile network operator, MNO, network.

The private routing table may be a virtual routing and forwarding, VRF, table.

One or more of the consumer networks may use Multiprotocol Label Switching, MPLS. In this case, the IP traffic may include labels to distinguish between the private networks.

The unique identifier may be a unique initiator identifier, which may be:
an IPV4 or IPv6 IP address;
a fully qualified domain name, FQDN;
a user ID, such as an email address assigned to the router (preferably an RFC 822 email address);
a binary Distinguished Encoding Rules (DER) encoding of an ASN.1 X.500 Distinguished Name;
a binary DER encoding of an ASN.1 X.509 GeneralName; and/or
an opaque octet stream that may be used to pass vendor-specific information necessary to do certain proprietary types of identification.

The unique identifier may be used by the gateway of a consumer network to differentiate between the tunnels and to send upstream IP traffic to the correct router via the correct tunnel.

The gateway may store a mapping between a unique network identifier of each private network and a unique identifier of each corresponding router, to determine how to route upstream IP traffic.

The private network may be a mobile private network, MPN.

The endpoints may be cellular devices or internet of things, IoT, devices, for example.

The gateway of a consumer network may be an IPSec Gateway.

As will be understood by the skilled person, a “tunnel” is a means by which data can be transmitted securely across an insecure network. The data is repackaged, typically using encryption, so that interception of the traffic does not compromise the data.

Determining from which private network the IP traffic originates may be understood as determining which private network serves the endpoint from which the IP traffic originates and/or determining via which private network the IP traffic is received.

Receiving IP traffic may comprise receiving IP traffic from one or more of the private networks. Receiving IP traffic “from one or more of the private networks” may be understood as receiving IP traffic from one or more endpoints, each endpoint being served by a respective private network and/or receiving IP traffic via one or more of the private networks.

Sending upstream IP traffic to the remote network via the tunnel corresponding to the private network from which the upstream IP traffic originates may comprise sending upstream IP traffic to the remote network via the tunnel corresponding to the private network from which the upstream IP traffic originates so that upstream IP traffic from the first endpoint and upstream IP traffic from the second endpoint are sent via different tunnels. In other words, traffic originating from the first endpoint is sent via a first tunnel to a first router of the remote network and traffic originating from the second endpoint is sent via a second tunnel that is different to the first tunnel to a second router of the remote network that is different to the first router of the remote network.

A range of one or more IP addresses may be allocated to each router. Each router may be configured to perform network address translation, NAT, on the IP traffic so that an IP address of each of the one or more endpoints served by the corresponding private network is translated to an IP address within the range of IP addresses allocated to the router. Each range of IP addresses allocated to each router may be non-overlapping with the ranges of IP addresses allocated to the other routers.

Beneficially, by mapping the IP addresses of the endpoints in the one or more consumer networks to defined ranges on the remote network side, the system may also prevent IP clashes between endpoints on the consumer side and network elements on the remote network side.

Moreover, by implementing network address translation at the remote network, each endpoint on the consumer side (where IP address may be reused and traffic routed correctly based on the private routing table) may be allocated a different IP address in the remote network to every other endpoint served by a different private network. In this way, the remote network is able to distinguish between endpoints that may have had the same IP address in the one or more consumer networks.

Performing network address translation on the IP traffic may comprise modifying upstream IP traffic (received from the one or more endpoints served by the private network corresponding to the router) so that an IP address of each of the one or more endpoints served by the corresponding private network is translated to an IP address within the range of IP addresses allocated to the router. In this way, a source IP address of upstream IP traffic from the first endpoint is translated from the IP address of the first endpoint to a first translated IP address and a source IP address of upstream IP traffic from the second endpoint is translated from the IP address of the second endpoint to a second translated IP address. Therefore, each range of IP addresses allocated to each router may be non-overlapping with the ranges of IP addresses allocated to the other routers, so that the second translated IP address is different to the first translated IP address.

Likewise, a destination address of downstream IP traffic to the first endpoint may be translated from the first translated IP address to the IP address of the first endpoint and a destination address of downstream IP traffic to the second endpoint may be translated from the second translated IP address to the IP address of the second endpoint.

There may be a shared range of IP addresses that is shared across all the routers. In other words, the routers may share a pool of IP addresses.

A range of IP address may be a range of any size. The range may in some cases be a range of 1 (i.e. a single IP address per router). In this case, “IP masquerading” is employed. In this scenario, the IP address of each endpoint in the private network corresponding to the router is translated by the router to the same IP address on the remote network side. Advantageously, the number of IP addresses needed on the remote network size is limited in this scenario to the number of private networks on the IPBB side.

Downstream data traffic may be translated by modifying the destination IP address from the single IP address allocated to the router back to the IP address of the true destination endpoint in the corresponding consumer network. The router may determine the correct IP address by mapping different ports of the router to different endpoints or by using connection tracking data stored during the upstream translation, for example. When performing network address translation for upstream communications, the router may maintain a connection tracking “conntrack” table that includes the source port, the source IP address, the destination port and the destination IP address. Downstream responses to endpoint-initiated communications may be un-translated using the same table.

Alternatively, each endpoint on the consumer side may be allocated a unique IP address in the remote network. Because each endpoint IP address may be shared with other endpoints in other private networks, it is not possible for a server in the remote network to reliably initiate a connection to one specific endpoint. Techniques exist for

A range does not need to be a continuous range and could be discontinuous or fragmented. In other words, more than one continuous range of one or more IP addresses could be allocated to a router. Each IP address in the overall pool is allocated to only one of the routers and is not allocated to any of the other routers.

The allocated ranges may change over time. For example, if a private network on the consumer side needs to serve more endpoints (and if the routers are not employing source masquerading), the router may need a larger pool of IP addresses to cope with the increased number of endpoints on the consumer side. In this case, the range of IP addresses allocated to the router may be increased.

The remote network may further comprise a destination server. Each router may be configured to communicate IP traffic with the destination server.

The IP traffic may be device management IP traffic. The destination server may be a device management server.

A first endpoint served by a first private network of the one or more private networks may have an IP address. The remote network may comprise a network element having an IP address that is the same as the IP address of the first endpoint.

IP address clashes between endpoints on the consumer network side and servers on the remote network side may be avoided by the proposed system.

Methods of communicating IP traffic between the one or more consumer networks and the remote network (preferably across the Internet) are also provided.

A method performed by the gateway of a consumer network of the one or more consumer networks in a system described above is provided. The consumer network comprises a plurality of private networks. A private routing table is used within the consumer network. The method comprises receiving a plurality of requests to establish a tunnel, so that each router can establish the tunnel between the router and the gateway of the consumer network (preferably via the Internet).

Each request may be received from a router corresponding to a private network of the plurality of private networks in the consumer network.

The method may further comprise responding to each of the requests to establish a tunnel, so that each router establishes the tunnel between the router and the gateway of the consumer network (preferably via the Internet).

A method performed by the gateway of the consumer network for routing internet protocol, IP, traffic in a system described above is provided. The consumer network comprises a plurality of private networks. A private routing table is used within the consumer network. The method comprises sending upstream IP traffic to the remote network via the tunnel corresponding to the private network from which the upstream IP traffic originates.

Upstream IP traffic may be sent to a router of the remote network via the tunnel corresponding to the private network from which the upstream IP traffic originates.

The method may further comprise receiving upstream traffic from one or more of the plurality of private networks and determining from which private network the upstream IP traffic originates. In other words, receiving upstream IP traffic from an endpoint via a respective private network and determining via which private network the upstream IP traffic was sent.

The method may further comprise receiving upstream IP traffic from the first endpoint. The method may further comprise determining that the upstream IP traffic is received via the first private network.

The method may further comprise receiving, at the gateway of the consumer network via one or more tunnels, downstream IP traffic destined for one or more endpoints served by the one or more private networks. The method may further comprise sending the downstream IP traffic from the gateway of the consumer network via the corresponding private network of the consumer network.

The gateway of the consumer network may not need to modify the traffic if the traffic is formed with the correct unique network identifier. In this case, the traffic may be forwarded via the private networks and the private routing table will ensure the traffic reaches the correct endpoint, without giving rise to an IP clash.

In other cases, the downstream IP traffic may be sent to the corresponding private network based on the tunnel via which the downstream IP traffic was received. In other words, the gateway of the consumer network may set a unique network identifier of the IP traffic based on via which tunnel the traffic was received. The unique network identifier indicates to which private network the traffic relates and is relevant when the private routing table is being used to forward the traffic to the destination endpoint.

Each of the one or more private networks of the consumer network may have a unique network identifier. The private network to which IP traffic relates may be determined based on a unique network identifier associated with the IP traffic.

A method of managing internet protocol, IP, traffic between the consumer network

and the remote network in the system described above is also provided. The method comprises, for each router, establishing the tunnel between the router and the gateway of the corresponding consumer network (preferably via the Internet).

A method of managing internet protocol, IP, traffic between the consumer network and the remote network in the system described above is also provided. The method comprises, receiving, at one or more of the routers, upstream IP traffic from one or more of the endpoints served by the private network corresponding to the router via the corresponding tunnel.

The method may comprise receiving, at a first of the routers, upstream IP traffic (via the corresponding tunnel) from one or more of the endpoints served by the corresponding (first) private network.

The method may comprise receiving, at one or more of the routers, upstream IP traffic via the corresponding tunnel from one or more of the endpoints served by the corresponding private network, wherein receiving upstream IP traffic from one or more of the one or more endpoints comprises receiving upstream IP traffic from the first endpoint at a first router via a first tunnel and receiving upstream IP traffic from the second endpoint at a second router via a second tunnel.

The method may further comprise allocating, for each router, a range of one or more IP addresses, wherein each range of IP addresses allocated to each router is non-overlapping with the ranges of IP addresses allocated to the other routers. The method may further comprise performing, at each router where upstream IP traffic is received, network address translation, NAT, on the received upstream IP traffic, so that a source IP address of upstream IP traffic is translated to an IP address within the allocated range of the router.

A range could be a range of 1. In other words, each router may have a single IP address and the source IP addresses may all be translated to that IP address. This method of IP masquerading is also described above.

Network address translation on the received upstream IP traffic may be performed so that a source IP address of upstream IP traffic is translated to an IP address within the allocated range of the router and thereby, a source IP address of upstream IP traffic from the first endpoint may be translated from the IP address of the first endpoint to a first translated IP address and a source IP address of upstream IP traffic from the second endpoint may be translated from the IP address of the second endpoint to a second translated IP address that is different to the first translated IP address

The method may further comprise receiving, at one or more of the routers of the remote network, downstream IP traffic destined for one or more of the one or more endpoints served by the corresponding private network. The method may further comprise performing at each router where downstream IP traffic is received, network address translation, NAT, on the received downstream IP traffic. The method may further comprise sending, at each router where downstream IP traffic is received, translated downstream IP traffic to the gateway of the corresponding consumer network via the corresponding tunnel.

Receiving downstream IP traffic destined for one or more of the one or more

endpoints served by the corresponding private network may comprise receiving downstream IP traffic destined for the first endpoint at a first router and receiving downstream IP traffic destined for the second endpoint at a second router. Downstream IP traffic destined for the first endpoint may have a destination IP address that is the first translated IP address and downstream IP traffic destined for the second endpoint may have a destination IP address that is the second translated IP address.

Receiving downstream IP traffic destined for one or more of the one or more endpoints served by the corresponding private network may comprise receiving the downstream IP traffic from the destination server.

Performing network address translation on the received IP traffic may comprise, performing network address translation so that a destination IP address of downstream IP traffic destined for the first endpoint is translated from the first translated IP address to the IP address of the first endpoint and the destination IP address of downstream IP traffic destined for the second endpoint is translated from the second translated IP address to the IP address of the second endpoint.

The remote network may further comprise a destination server. The method may further comprise sending, from each router where upstream IP traffic is received, translated upstream IP traffic to the destination server.

The unique network identifier may be:
an access point name, APN;
a unique router identifier; and/or
a unique IP address.

Each APN may be unique.

The IP traffic may be IPv4 traffic.

Each router in the remote network may have an external public IP address that is the same as an external public IP address of each of the other routers in the remote network. The gateway of each of the consumer networks may be configured to send IP traffic via a tunnel to a corresponding router. The corresponding router may be identified using the unique identifier of the router.

Each router in the remote network may have a fully qualified domain name, FQDN, that is different to a FQDN of each of the other routers in the remote network.

The remote network may further comprise a gateway having an external public IP address that is the same as the external public IP address of each of the routers in the remote network and configured to communicate IP traffic between the gateway of each consumer network and each of the one or more routers, based on the unique identifier.

The NAT gateway may provide a single node for the shared external IP address so that traffic (which may be routed via the Internet) arrives at the NAT gateway based on the external IP address and is then routed to the correct router by the NAT gateway, based on the FQDN of the router.

The tunnels may be secure tunnels. For example, the tunnels may be Internet Protocol Security, IPSec tunnels. Alternatively, the tunnels may be: Generic Routing Encapsulation, GRE, tunnels; OpenVPN tunnels; Secure Socket Tunneling Protocol, SSTP, tunnels; Layer 2 Tunneling Protocol, L2TP, tunnels; Virtual Extensible Local Area Network, VXLAN, tunnels or WireGuard tunnels.

The gateway of one or more of the consumer networks may be a virtual gateway.

The gateway of the remote network may be a virtual gateway.

The destination server may be a virtual server.

Each router may be a virtual router.

The virtual routers may be contained within a compute cluster (such as a Kubernates cluster).

Each virtual router may be implemented in a separate virtualised container (which may be a Kubernetes pod).

Each virtual router may be a Strongswan router.

The remote network may be a Cloud Service Provider, CSP.

A Cloud Service Provider may establish publicly-accessible cloud services, manage private cloud services, or offer on-demand cloud computing components and services. These may include Infrastructure-as-a-Service (IaaS), Platform-as-a-Service (PaaS), and Software-as-a-Service (SaaS). Cloud services may be more flexible and easier to implement than on-premises IT equipment. However, there may be additional networking requirements to connect to cloud services and cloud services may be limited in ways that on-premises IT equipment is not.

A method performed by a gateway of a consumer network is provided. The method comprises receiving, from a remote network, a plurality of requests to establish a tunnel. Each request is received from a respective router of the remote network. Each router has a unique identifier. Each router corresponds to a private network of the consumer network. A tunnel is established between each router of the private network and the gateway of the consumer network (preferably via the Internet).

A method for routing internet protocol, IP, traffic between a gateway of a consumer network and a remote network is provided. The method comprises receiving, at the gateway of the consumer network, upstream IP traffic. The consumer network comprises a plurality of private networks. The method further comprises determining from which of the plurality of private networks the upstream IP traffic originates. The remote network comprises a plurality of routers, wherein a router is provided for each of the plurality of private networks in the consumer network. The method further comprises sending upstream IP traffic from the gateway of the consumer network to a router of the remote network (preferably via the Internet), based on from which private network the upstream IP traffic originates.

Each router in the remote network has a unique identifier and is configured to establish a tunnel between the router and the gateway of the consumer network (preferably via the Internet), so that each tunnel corresponds to a private network of the plurality of private networks in the consumer network.

The tunnels between router and gateway may be established via the Internet in some examples. In other examples, the system could be implemented in a private solution, so that the tunnels are established via an alternative network (such as a Mobile Private Network).

A method of managing internet protocol, IP, traffic between one or more consumer networks and a remote network is also provided. The remote network comprises a plurality of routers, each having a unique identifier. Each of the plurality of routers in the remote network corresponds with a private network in the one or more consumer networks. The method comprises, for each router, establishing the tunnel between the router and a gateway of the corresponding consumer network (preferably via the Internet).

A method of managing internet protocol, IP, traffic between one or more consumer networks and a remote network is also provided. The remote network comprises a plurality of routers, each having a unique identifier. The method comprises receiving, at one or more of the routers, upstream IP traffic from one or more endpoints, each served by a private network in the one or more consumer networks. Each router corresponds to a private network so that upstream IP traffic is received by the router corresponding to the private network that serves the endpoint from which the IP traffic originates.

Each router in the remote network may be configured to establish a tunnel between the router and the gateway of the consumer network (preferably via the Internet), so that each tunnel corresponds to a private network in the one or more consumer networks.

These methods may be performed in the systems described above. Optional features discussed above are equally applicable to these methods, as will be appreciated by the skilled person.

A computer program is also provided. The computer program comprises instructions that, when executed by a processor, cause the processor to perform a method as described above.

### BRIEF DESCRIPTION OF THE DRAWINGS

The present invention will now be described with reference to a number of non-limiting examples illustrated in the Figures.

FIG. 1 illustrates IP clashing between a consumer network comprising multiple private networks and a cloud-hosted device management service.

FIG. 2 illustrates a specific example of a system for routing internet protocol, IP, traffic.

FIG. 3A illustrates consumer side and remote side implementation of an example system.

FIG. 3B illustrates consumer side and remote side implementation of another example system.

FIG. 4A illustrates a system for routing internet protocol, IP, traffic.

FIG. 4B illustrates another system for routing internet protocol, IP, traffic.

FIG. 5 illustrates a further system for routing internet protocol, IP, traffic.

FIG. 6 illustrates a method performed by the gateway of a consumer network.

FIG. 7 illustrates a method of managing internet protocol, IP, traffic between a consumer network and a remote network.

### DETAILED DESCRIPTION

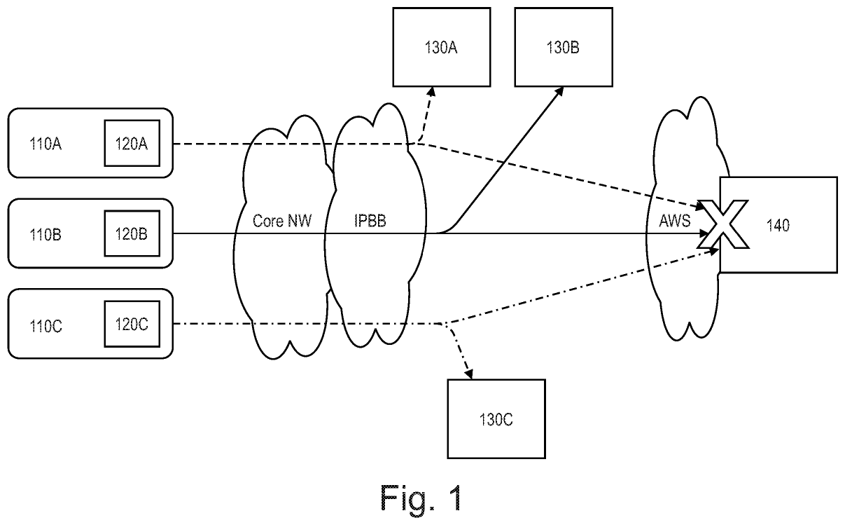

FIG. 1 illustrates the problem of IP clashing between a consumer network comprising multiple private networks and a cloud-hosted device management service. As illustrated, the consumer network comprises three private networks 110A to 110C, which may belong to three different customers of the consumer network (so may be referred to as “customer networks”). In this specific example, the first private network 110A has an allocated IP range of 10.192.0.0/13 and comprises a first device 120A. The second private network 110B has an allocated IP range of 10.192.0.0/13 and comprises a second device 120B. The third private network 110C has an allocated IP range of 10.192.0.0/13 and comprises a third device 120C. The IP Ranges in this example are identical sizes and completely overlap. In other examples, the allocated IP ranges may not be identical but may nevertheless overlap. The allocated ranges can be on any size, depending on the needs of the customer.

In the above example, each customer has their own private network. However, it is also possible for one or more customers to have a shared VRF, which means their traffic is interspaced with other customer traffic within the VRF.

A first customer endpoint 130A is served by the first private network 110A. A second customer endpoint 130B is served by the second private network 110B. A third customer endpoint 130C is served by the third private network 110C. Since the IP ranges of the private networks

A device management server 140 is hosted by a cloud service provider. Split routing is permitted so traffic can reach both the device management server 140 and the endpoint.

The consumer network (illustrated as a Core NW and an IPBB) can segregate device traffic using private routing tables (in other words, they are VRF aware). Therefore, the overlapping IP address ranges is not a problem for the consumer network. However, device management traffic is send to a remote device management server (in this case, hosted in an AWS cloud). Once the traffic arrives in the remote network, there is no way for the remote network to tell from which private network the traffic came. Therefore, different endpoints in different private networks may appear the same to the remote network. Because of IP address reuse, the source IP addresses may appear the same to the remote network. This therefore causes an IP clash.

In other words, the problem of IP clash occurs because, from a connectivity perspective, once the device traffic reaches the device management server 140, there is no awareness of the private networks (no VRF awareness). Therefore, the device management server 140 does not know which device is which since the source IP addresses may be the same.

There are also several other complicating factors, which include:
Customers can have small/22 or large/10 CIDR ranges of IP addresses so allocation of a slice from a single central shared range may not be feasible (and may negatively impact performance from a network perspective).
Customers don't want to change their device IPs as their own systems are expecting specific ranges.
Many datacentres and cloud providers do not support VRF awareness
In order to provide certain additional services (e.g. Device Management) disparate customers with private APNs require access to a central platform.

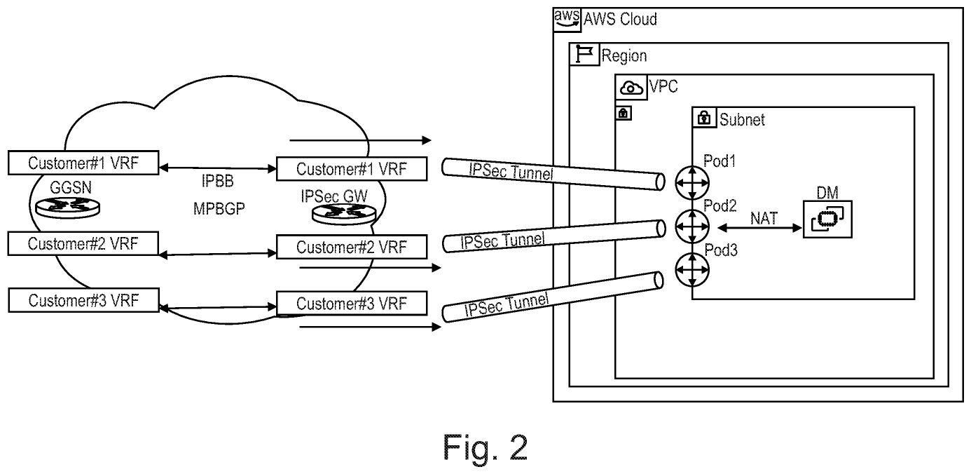

To implement a specific example of the proposed solution, a pair of new StrongSwan (virtual routers) instances are created in their own Kubernates Pods at the AWS side (primary and failover) for each customer during onboarding. This is illustrated in FIG. 2.

In the IPBB, each VRF is identified by RTs. Each VRF prefixes (including the static route to reach the DM IP) are exchanged using the MPBGP inside IPBB until it reaches the GGSN.

The proposed solution provides a static route from each VRF to reach the DM IP pointing towards the IPSec tunnel and redistributed to BGP under each VRF, so it can be advertised inside the IPBB.

IPSec between two fixed IPs and the differentiation between the tunnels is being done using FQDN.

Strongswan acts as an IPSec initiator and keeps the VRF separation but via Pods and not RTs.

These new PODs will initiate a tunnel back to the consumer network IPSEC GW using same single external public IP but different FQDN for Security Association (in other words, the EDGE router at the consumer network side uses the label FQDN to differentiate between the IPSECs originating from the remote network side).

These PODs will NAT the source traffic using a shared pool across all the PODs in the Kubernates group.

Device traffic will enter the IPSEC through the use of a Static route set up within the customers VRF. In other words, the EDGE router is VRF aware and will select the correct IPSEC based on the customers VRF.

As a result, the proposed system enables terminating disparate Customer APN traffic to a central service. This is a technically complex problem that has remained unsolved in the industry for a long time (more than 4 years). The proposed solution addresses this complex problem with an elegant design. As a result, the proposed solution addresses a long-felt need to enable device management capabilities for customers.

One issue faced by consumer networks is that network components that would provide more IP addresses are not available. This is at least in part because IPv6 is not widely adopted in the industry. Therefore, a solution that does not rely on IPV6 is desirable.

By using FQDNs to create multiple tunnels, the same source and destination IPs may be used (thereby reducing the number of external IP addresses required to address the routers in the remote network). This can reduce networking overheads.

By using containerisation (e.g. Pods/Kubernates), the proposed solution is scalable and provides redundancy.

By using a Static route, BGP route leaking may not be needed.

The proposed solution is flexible and can be implemented with standard (out of the box) building blocks. This can also ensure maintainability of the deployment and reduce costs.

A number of other options for terminating disparate Customer APN traffic to a central service have been proposed: .
Slice up RFC 1918 range/IPSECs/New Direct Connect. This limits the number of devices a customer can have. Additionally, this is expensive and not scalable.
Provide separate VPCs at AWS each with new transit GW and NAT solution. This is expensive (because of the number of transit gateways required).
Provide a NAT GW. In other words, implement IPV6 in the whole deployment. This involves new Core Network hardware, which is expensive and has a long lead time. Moreover, the target platform would need to support IPV6 (which is not widely available).
Provide a new destination server (a centralised target platform such as a DM deployment) per customer. This is effectively deploying a new E2E solution on a per customer basis (means deploying a destination server for each customer). This would not be scaleable and would require many new networking resources for each customer.

The consumer network IP Backbone side (IPBB) may comprise a customer VRF created with a unique RT. The customer's APN may be created at the GGSN side and attached to the previously configured VRF, along with IP Pool: 10.192.0.0/13. At the IPSec Gateway, the below steps may be taken during set up:
Import the Customer's VRF:
Establish primary IPSEC tunnel for customer.
Configure the IPSec gateway to be an IPSec responder for the IPSec tunnel associated with the VRF using the FQDN feature as the source and destination IPs of the tunnels are fixed so the identification for the Preshared key and also the Tunnel profile will be based on FQDN.
Routing the Traffic in the tunnel by allowing the traffic from the APN IP pool to pass through the tunnel using the IP Access list and Cryptomap.
Configure a static route to send the traffic towards the tunnel to reach the destination server and then advertising this default route inside the customer's VR.
Redistributing the Static route to the customer's VRF and send it inside the Backbone network using MPBGP so the GGSN can see it and forward the traffic to the DM

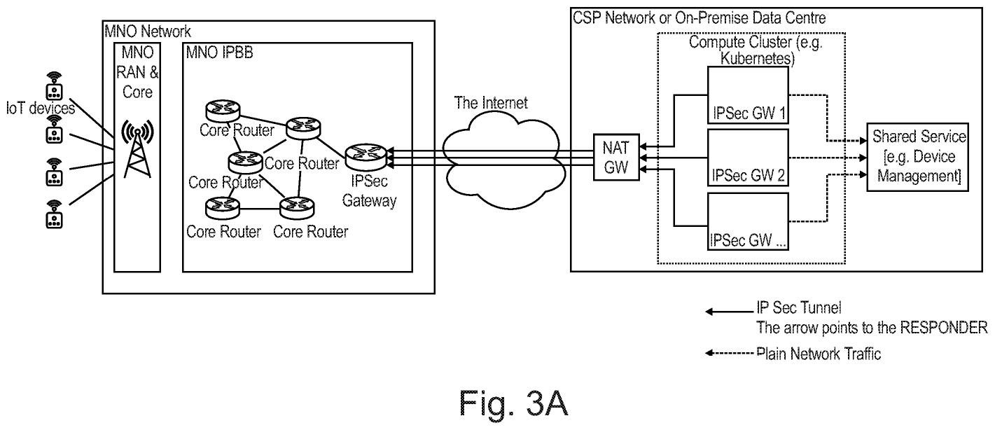

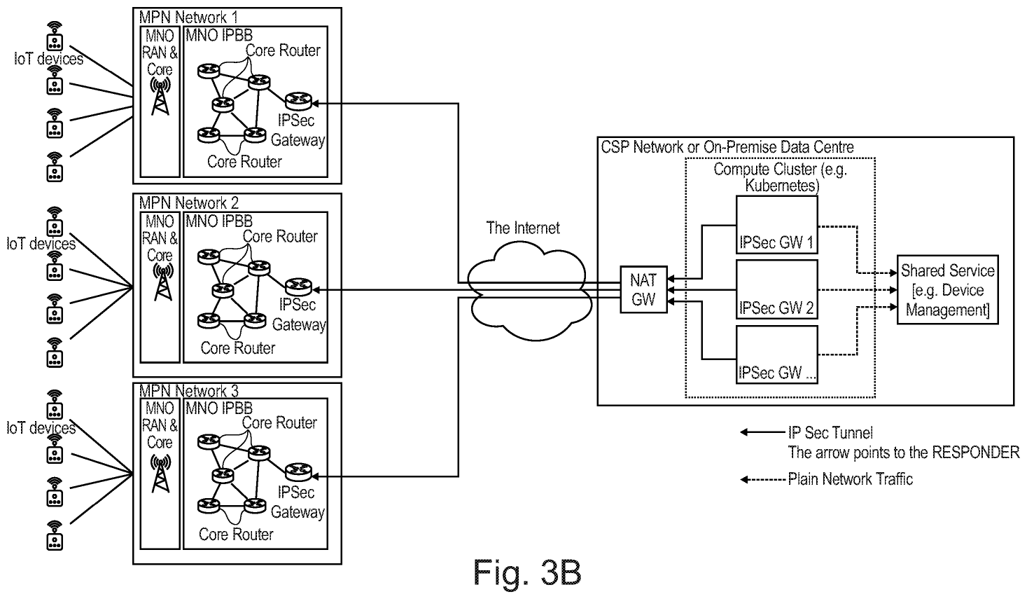

The consumer side and remote (cloud) side implementation of an example system is illustrated in FIG. 3A. The Cloud Service Provider (CSP) or on-premises infrastructure provides the following network and compute components:
NAT GW (Network Address Translation Gateway).
Compute Units, which could be one of the following:
   Kubernetes Pod
   Containers
   Virtual Machines
   Physical Computers
[Recommended but Optional] Compute Cluster Management. E.g. Kubernetes. This to handle the scaling out/in and auto-recovery of failing working nodes.

Most major CSPs (such as Google Cloud Platform, GCP by Google, Amazon Web Services, AWS by Amazon and Azure by Microsoft) offer the above components as managed services.

Another example is illustrated in FIG. 3B. In this example, the remote network is in communication with a plurality of consumer networks, each consumer network having a separate gateway.

In this example, “a private routing table” may not be needed because the traffic is segregated between consumer networks. IP addresses from one consumer network may be reused in another, which could otherwise cause IP clash in the remote network. The claimed invention therefore applies equally where multiple consumer networks are present.

The solution may include software for handling IPSec IKE and ESP protocol communication. For example, a Linux based operating system may be provided, along with a keying daemon like StrongSwan.

### Example Setup Using Kubernetes and StrongSwan

Setup A Kubernetes cluster.
Setup NAT Gateway with a public IPv4 address attached to it.
Configure the network route tables (depending on the CSP/On-Premise Infrastructure) such that all traffic with MNO IPSec Gateway as the destination to go through NAT Gateway.

### Customer Onboarding

1. Per each new customer, a dedicated IPSec tunnel needs to be established and maintained.
2. A suitable IPv4 Private Address pool needs to be allocated to the customer that does not overlap with other customers address pools.
   The IPV4 Private address pool will not be attached to any network nodes. It will be only used in NAT (more on that below)
   The IPv4 Private address pool allocation could be automatic (ie. via a software/script) or manual.
   The IPV4 Private address pool allocation could be static (i.e. fixed set of IPV4 addresses) or dynamic (i.e. changes according to some parameters like traffic distribution between the IPSec tunnels)
   The IPV4 Private address pool could consist of a single IP address that is assigned to IPSec GW, in this case, it is called IP masquerading.
3. The customer IPSec tunnel will have a dedicated Kubernetes Pod which hosts the IPSec software.
   An example of such software is the open-source StrongSwan software as IPSec keying daemon running on top of a Linux-based operating system. But the solution presented here can be implemented with other IPSec software.
4. The IPSec Kubernetes Pod dedicated for the IPSec tunnel should:
   Initiate the IKE connection over UDP according to what is called NAT Traversal [check: Internet Key Exchange Protocol Version 2 (IKEv2) Section 2.23].
   Once the IPSec Security Association is established, apply Source NATing on all IPv4 traffic coming from the IPSec tunnel (after decryption) to a non-overlapping IPv4 Address pool.
   [Optional] In case that the Shared Service does not have a public IPv4 address, then Destination NATing could also take place in the Pod.
   Route the NATed traffic to the Shared Service Destination.

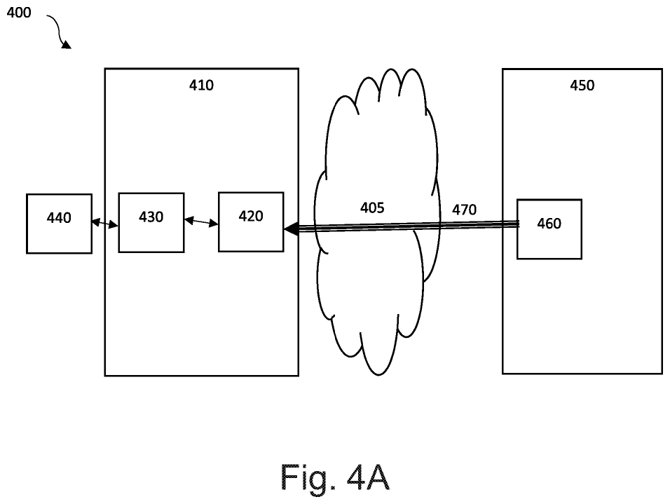

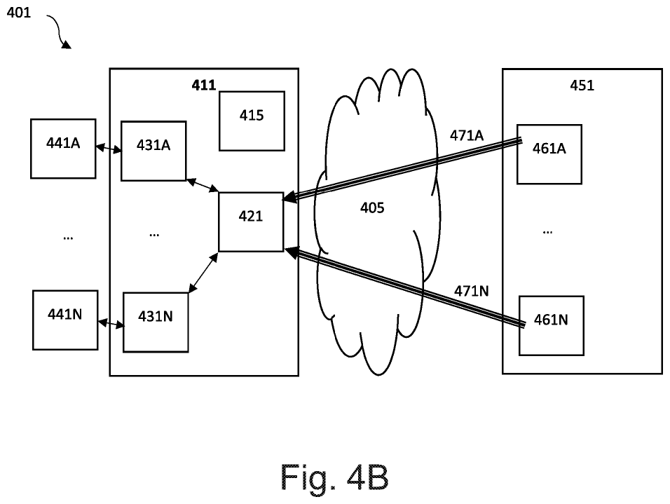

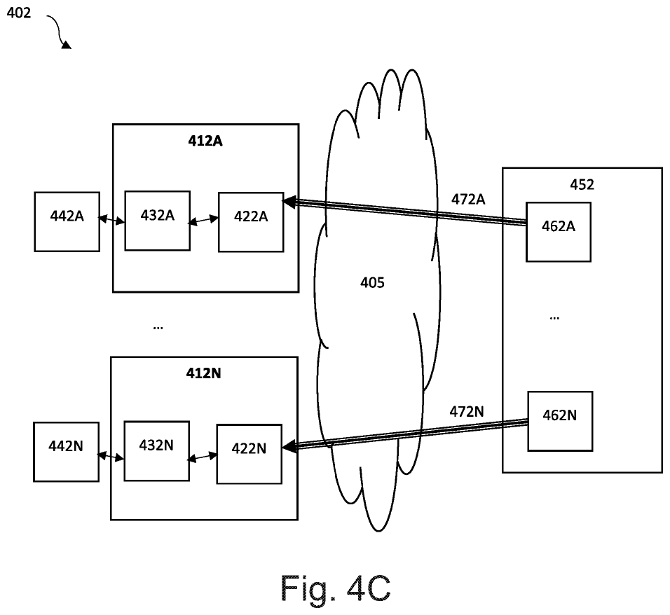

FIG. 4A illustrates a system 400 for routing internet protocol, IP, traffic. The system comprises a consumer network 410 comprising a gateway 420 and a private network 430. The private network 430 serves at least one endpoint 440.

The system 400 further comprises a remote network 450 comprising a router 460 corresponding to private network 430 in the consumer network 410. The router 460 in the remote network 450 has a unique identifier and is configured to establish a tunnel 470 between the router 460 and the gateway 420 of the consumer network 410 via the Internet 405, so that the tunnel 470 corresponds to the private network 430 in the consumer network 410.

The gateway 420 of the consumer network 410 is configured to receive upstream IP

traffic. The gateway 420 of the consumer network 410 is further configured to send the upstream IP traffic to the remote network 450 via the tunnel 470 corresponding to the private network 430 from which the upstream IP traffic originates.

Advantageously, the router 460 may be configured to perform network address translation on the received upstream traffic. As a result, IP clash can be avoided between the endpoint 440 in the private network and devices in the remote network.

FIG. 4B illustrates a system 401 for routing internet protocol, IP, traffic. The system comprises a consumer network 411 comprising a gateway 421 and a plurality of private networks 431A to 431N. Each of the plurality of private networks 431A to 431N serves one or more endpoints 441A to 441N. A first endpoint 441A served by a first private network 421A of the plurality of private networks has an IP address and a second endpoint 441B separate from the first endpoint 441A and served by a second private network 431B of the plurality of private networks has an IP address that is the same as the IP address of the first endpoint 441A. A private routing table 415 is used within the consumer network 411 so that IP traffic to and from the first endpoint 441A and IP traffic to and from the second endpoint 441B is correctly routed within the consumer network 411.

The system 401 further comprises a remote network 451 comprising a router 461A to 461N for each of the plurality of private networks 431A to 431N in the consumer network 411. Each router 461A to 461N in the remote network 451 has a unique identifier and is configured to establish a tunnel 471A to 471N between the router 461A to 461N and the gateway 421 of the consumer network 411 via the Internet 405, so that each tunnel 471A to 472N corresponds to a private network of the plurality of private networks 431A to 431N in the consumer network 411.

The gateway 421 of the consumer network 411 is configured to receive upstream IP traffic. The gateway 421 of the consumer network 411 is further configured to determine from which private network 431A to 431N the upstream IP traffic originates. The gateway 421 of the consumer network 411 is further configured to send the upstream IP traffic to the remote network 451 via the tunnel 471A to 471N corresponding to the private network 431A to 431N from which the upstream IP traffic originates.

FIG. 4C illustrates a system 402 for routing internet protocol, IP, traffic. The system comprises a plurality of consumer networks 412A to 412N, each comprising a gateway 422A to 422N and at least one private network 432A to 432N. Each of the private networks 432A to 432N serves at least one endpoint 442A to 442N. A first endpoint 442A served by a private network 432A of the first consumer network 412A has an IP address and a second endpoint 442N separate from the first endpoint 442A and served by a second private network 432N of the second consumer network 412N has an IP address that is the same as the IP address of the first endpoint 442A.

The system 402 further comprises a remote network 452 comprising a router 462A to 462N for each of the private networks 442A to 442N in the plurality of consumer networks 412A to 412N. Each router 462A to 462N in the remote network 452 has a unique identifier and is configured to establish a tunnel 472A to 472N between the router 462A to 462N and the gateway 422A to 422N of the corresponding consumer network 412A to 412N via the Internet 405, so that each tunnel 472A to 472N corresponds to a private network 432A to 432N in the plurality of consumer networks 412A to 412N.

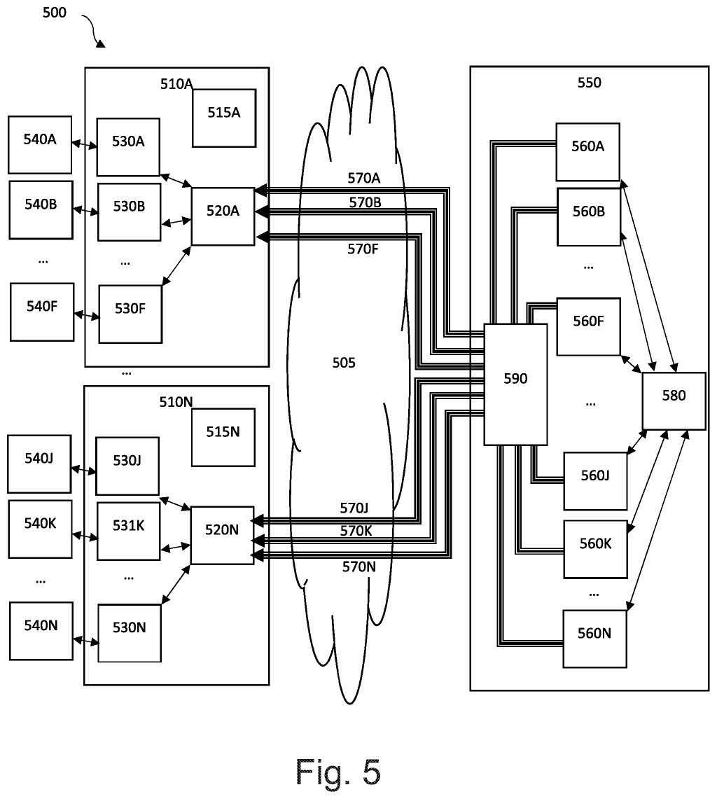

FIG. 5 illustrates a system 500 for routing internet protocol, IP, traffic according to a specific example. The system 500 of FIG. 5 comprises a plurality of consumer networks 510A to 510N, each comprising a gateway 520A to 520N and a plurality of private networks 530A to 530N, each of which serves one or more endpoints 540A to 540N. A private routing table 515A to 515N is used within each consumer network 510A to 510N. As with the system 400 of FIG. 4, the system 500 of FIG. 5 further comprises a remote network 550 comprising a router 560A to 560N for each of the plurality of private networks 530A to 530N in the plurality of consumer networks 510A to 510N. Each router 560A to 560N is configured to establish a tunnel 570A to 570N between the router 560A to 560N and the gateway 520A to 520N of the corresponding consumer network 510A to 510N via the Internet 505.

The remote network 550 further comprises a destination server 580. Each router 560A to 560N is configured to communicate IP traffic with the destination server 580. The remote network further comprises a gateway 590 having an external public IP address that is the same as the external public IP address of each of the routers 560A to 560N in the remote network 550 and configured to communicate IP traffic between the gateway 420 of the consumer network and each of the one or more routers 560A to 560N.

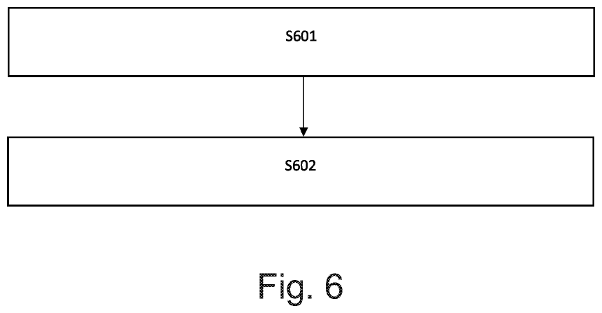

FIG. 6 illustrates a method performed by a gateway of a consumer network. The method comprises one or both of the following steps:
S601: receiving a plurality of requests to establish a tunnel, so that each router can establish the tunnel between the router and the gateway of the consumer network via the Internet; and/or
S602: sending upstream IP traffic to the remote network via the tunnel corresponding to the private network from which the upstream IP traffic originates.

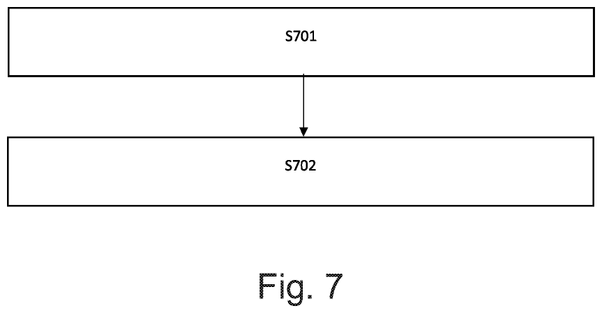

FIG. 7 Illustrates a method of managing internet protocol, IP, traffic between a consumer network and a remote network. The method comprises one or both of the following steps:
S701: for each router, establishing the tunnel between the router and the gateway of the corresponding consumer network via the Internet; and/or
S702: receiving, at one or more of the routers, upstream IP traffic from one or more of the endpoints served by the private network corresponding to the router via the corresponding tunnel.

Where the above description refers to a consumer network, this may refer to an IP backbone, IPBB, network. Alternatively, this may refer to a core network. Alternatively, the “consumer network” may be both the IPBB network and the core network, or could be an entire mobile network operator, MNO, network.

Where the above description refers to a customer, this is a customer of the MNO operating the consumer network. In some examples, each customer is provided with their own private network in the consumer network by the MNO. In other examples, a private network may be divided between multiple customers.

The above description refers to the problem of a restricted number of IP address. Therefore, the invention is particularly useful in IPv4 systems, in which the number of available IP addresses is limited. In future systems where IPV6 is supported, the number of available IP addresses will increase. However, the total number of addresses in IPV6 is still finite and there may be a desire to reduce the number of addresses required in certain scenarios. Therefore, the present solution is equally applicable to IPV6 systems.

Moreover, the present invention provides advantages beyond limiting the number of public IP addresses required. For example, the problem of IP clash between endpoints on the consumer side and network elements in the remote network may still exist in an IPV6 system. This problem is addressed by the proposed solution. Therefore, the present solution also provides benefits in an IPV6 system.

Even if IPv6 is more widely adopted in future, there may be specific instances where it is preferable to use IPv4 over IPv6. For example, in low-bandwidth and/or low-power situations (such as for battery powered monitoring devices set up in remote locations), it may be important to reduce overall packet size as much as possible. Therefore, IPv4 addresses consisting of 32 bits (four bytes) may be preferable to IPV6addresses consisting of 128 bits (16 bytes). In such cases where use of IPV4 is desirable the present invention continues to provide benefits as described above.

Where the description refers to a server, a gateway or a router, for instance, this may actually be a pair of servers, gateways or routers (primary and failover), for redundancy.

It will be appreciated that embodiments of the disclosure may be implemented using a variety of different information processing systems. In particular, although the figures and the discussion thereof provide exemplary computing systems and methods, these are presented merely to provide a useful reference in discussing various aspects of the disclosure. Embodiments may be carried out on any suitable data processing device, such as a personal computer, laptop, personal digital assistant, mobile telephone, set top box, television, server computer, etc. Of course, the description of the systems and methods has been simplified for purposes of discussion, and they are just one of many different types of systems and methods that may be used. It will be appreciated that the boundaries between logic blocks are merely illustrative and that alternative embodiments may merge logic blocks or elements, or may impose an alternate decomposition of functionality upon various logic blocks or elements.

It will be appreciated that the above-mentioned functionality may be implemented as one or more corresponding modules as hardware and/or software. For example, the above-mentioned functionality may be implemented as one or more software components for execution by a processor of the system. Alternatively, the above-mentioned functionality may be implemented as hardware, such as on one or more field-programmable-gate-arrays (FPGAs), and/or one or more application-specific-integrated-circuits (ASICs), and/or one or more digital-signal-processors (DSPs), and/or other hardware arrangements. Method steps implemented in flowcharts contained herein, or as described above, may each be implemented by corresponding respective modules. Moreover, multiple method steps implemented in flowcharts contained herein, or as described above, may be implemented together by a single module.

It will be appreciated that, insofar as embodiments of the disclosure are implemented by a computer program, then a storage medium and a transmission medium carrying the computer program form aspects of the disclosure. The computer program may have one or more program instructions, or program code, that, when executed by a computer, causes an embodiment of the disclosure to be carried out. The term “program” as used herein, may be a sequence of instructions designed for execution on a computer system, and may include a subroutine, a function, a procedure, a module, an object method, an object implementation, an executable application, an applet, a servlet, source code, object code, a shared library, a dynamic linked library, and/or other sequences of instructions designed for execution on a computer system. The storage medium may be a magnetic disc (such as a hard drive or a floppy disc), an optical disc (such as a CD-ROM, a DVD-ROM or a BluRay disc), or a memory (such as a ROM, a RAM, EEPROM, EPROM, Flash memory or a portable/removable memory device), etc. The transmission medium may be a communications signal, a data broadcast, a communications link between two or more computers, etc.

Each feature disclosed in this specification, unless stated otherwise, may be replaced by alternative features serving the same, equivalent or similar purpose. Thus, unless stated otherwise, each feature disclosed is one example only of a generic series of equivalent or similar features.

As used herein, including in the claims, unless the context indicates otherwise, singular forms of the terms herein are to be construed as including the plural form and, where the context allows, vice versa. For instance, unless the context indicates otherwise, a singular reference herein including in the claims, such as “a” or “an” (such as a server, a gateway, a private routing table, a tunnel, a router, or an endpoint) means “one or more” (for instance, one or more servers, one or more gateways, one or more private routing tables, one or more tunnels, one or more routers or one or more endpoints). Throughout the description and claims of this disclosure, the words “comprise”, “including”, “having” and “contain” and variations of the words, for example “comprising” and “comprises” or similar, mean that the described feature includes the additional features that follow, and are not intended to (and do not) exclude the presence of other components.

The use of any and all examples, or exemplary language (“for instance”, “such as”, “for example” and like language) provided herein, is intended merely to better illustrate the disclosure and does not indicate a limitation on the scope of the disclosure unless otherwise claimed. No language in the specification should be construed as indicating any non-claimed element as essential to the practice of the disclosure.

Any steps described in this specification may be performed in any order or simultaneously unless stated or the context requires otherwise. Moreover, where a step is described as being performed after a step, this does not preclude intervening steps being performed.

All of the aspects and/or features disclosed in this specification may be combined in any combination, except combinations where at least some of such features and/or steps are mutually exclusive. In particular, the preferred features of the disclosure are applicable to all aspects and embodiments of the disclosure and may be used in any combination. Likewise, features described in non-essential combinations may be used separately (not in combination).

A method of manufacturing and/or operating any of the devices disclosed herein is also provided. The method may comprise steps of providing each of the features disclosed and/or configuring or using the respective feature for its stated function.

1. A system for routing internet protocol, IP, traffic, the system comprising:
one or more consumer networks, each consumer network comprising a gateway and one or more private networks, wherein each of the one or more private networks serves one or more endpoints; and
a remote network comprising a router for each of the one or more private networks in each of the one or more consumer networks, wherein each router in the remote network has a unique identifier and is configured to establish a tunnel between the router and the gateway of the corresponding consumer network, so that each tunnel corresponds to a private network of the one or more private networks in the one or more consumer networks, wherein the gateway of each consumer network is configured to:
receive upstream IP traffic;
determine from which private network in the consumer network the upstream IP traffic originates; and
send the upstream IP traffic to the remote network via the tunnel corresponding to the private network from which the upstream IP traffic originates.

2. The system of claim 1, wherein a range of one or more IP addresses is allocated to each router, and wherein each router is configured to perform network address translation, NAT, on the IP traffic so that an IP address of each of the one or more endpoints served by the corresponding private network is translated to an IP address within the range of IP addresses allocated to the router, wherein each range of IP addresses allocated to each router is non-overlapping with the ranges of IP addresses allocated to the other routers.

3. The system of claim 1, wherein the remote network further comprises a destination server, and wherein each router is configured to communicate IP traffic with the destination server.

4. A method performed by the gateway of a consumer network of the one or more consumer networks, in the system of claim 1, wherein the consumer network comprises a plurality of private networks, wherein a private routing table is used within the consumer network the method comprising:
receiving a plurality of requests to establish a tunnel, so that each router can establish the tunnel between the router and the gateway of the consumer network; and/or sending upstream IP traffic to the remote network via the tunnel corresponding to the private network from which the upstream IP traffic originates.

5. The method of claim 4, further comprising:
receiving upstream IP traffic from the first endpoint; and
determining that the upstream IP traffic is received via the first private network.

6. The method of claim 4, further comprising:
receiving, at the gateway of the consumer network via one or more tunnels, downstream IP traffic destined for one or more endpoints served by the one or more private networks;
sending the downstream IP traffic from the gateway of the consumer network via the corresponding private network of the consumer network.

7. The method of claim 4, wherein each of the one or more private networks of the consumer network has a unique network identifier, and wherein the private network to which IP traffic relates is determined based on a unique network identifier associated with the IP traffic.

8. A method of managing internet protocol, IP, traffic between the one or more consumer networks and the remote network in the system of claim 1, the method comprising:
for each router, establishing the tunnel between the router and the gateway of the corresponding consumer network; and/or
receiving, at one or more of the routers, upstream IP traffic from one or more of the endpoints served by the private network corresponding to the router via the corresponding tunnel.

9. The method of claim 8, further comprising:
for each router, allocating a range of one or more IP addresses, wherein each range of IP addresses allocated to each router is non-overlapping with the ranges of IP addresses allocated to the other routers; and
at each router where upstream IP traffic is received, performing network address translation, NAT, on the received upstream IP traffic, so that a source IP address of upstream IP traffic is translated to an IP address within the allocated range of the router.

10. The method of claim 8 further comprising:
receiving, at one or more of the routers of the remote network, downstream IP traffic destined for one or more of the one or more endpoints served by the corresponding private network;
at each router where downstream IP traffic is received, performing network address translation, NAT, on the received downstream IP traffic;
at each router where downstream IP traffic is received, sending translated downstream IP traffic to the gateway of the corresponding consumer network via the corresponding tunnel.

11. The method of claim 8, wherein the remote network further comprises a destination server, the method further comprising:
at each router where upstream IP traffic is received, sending translated upstream IP traffic to the destination server.

12. The method of claim 8, wherein each router in the remote network has an external public IP address that is the same as an external public IP address of each of the other routers in the remote network, wherein the gateway of each of the consumer networks is configured to send IP traffic via a tunnel to a corresponding router, wherein the router is identified using the unique identifier of the router.

13. The method of claim 12, wherein the remote network further comprises a gateway having an external public IP address that is the same as the external public IP address of each of the routers in the remote network and configured to communicate IP traffic between the gateway of each consumer network and each of the one or more routers, based on the unique identifier.

14. The method of claim 8, wherein:
the gateway of one or more of the consumer networks is a virtual gateway;
the remote network further comprises a gateway and the gateway of the remote network is a virtual gateway;
each router is a virtual router;
each router is a virtual router implemented in a separate virtualised container; and/or
the remote network further comprises a destination server and the destination server is a virtual destination server.

15. A computer program comprising instructions that, when executed by a processor, cause the processor to perform the method of claim 8.
